(19) United States
(12) Patent Application Publication
(10) Pub. No.: US 2026/0339085 A1
(43) Pub. Date: Oct. 29, 2026

(54) Moveable Confocal Optical Module

(71) Applicant: Sartorius BioAnalytical Instruments, Inc., Bohemia, NY (US)

(72) Inventors: Paul Bierdz, Ann Arbor, MI (US); Nevine Holtz, Saline, MI (US); Andrey Klishin, Foster City, CA (US); Michael Kusner, Ann Arbor, MI (US); Kyle Schutte, Ann Arbor, MI (US)

(21) Appl. No.: 19/187,189

(22) Filed: Apr. 23, 2025

(51) Int. Cl. G02B 21/00

(52) U.S. Cl. CPC G02B 21/0032; G02B 21/0076; G02B 21/008

(57) ABSTRACT

An optical instrument includes an enclosure that includes a window and a port. The port is configured to receive a first light via an optical cable. The instrument includes a stage for sup-porting samples and an objective configured to be aligned with the window such that the first light exiting the enclosure through the window enters the objective and a second light from the objective enters the enclosure through the window. The instrument includes, within the enclosure, an optical module including a plate having openings patterned for spinning-disc confocal microscopy and an image sensor. The optical module is configured to illuminate the samples with the first light and capture images of second light from the samples. The optical instrument further includes a cable guide configured to facilitate movement of the optical cable within a first plane and within a second perpendicular plane that occurs in response to the enclosure moving.

### BACKGROUND

Researchers from many scientific fields value information that can be obtained from imaging live cells, for example, from detecting and quantifying the fluorescent emissions of cells over long periods of time under physiologically relevant environmental conditions. Some imaging systems include a small transparent environmental chamber that is attached to the stage of a small microscope. The environmental chamber holding the live cells can be moved so that different samples can be aligned with the imaging system. However, such movement can mechanically disturb the biological samples, which can adversely affect the data obtained using the instrument.

### SUMMARY

A first example is an optical instrument comprising: an enclosure comprising: a window; and a port configured to receive a first light via an optical cable; a stage configured to support one or more biological samples; an objective configured to be aligned with the window such that the first light exiting the enclosure through the window enters the objective and a second light from the objective enters the enclosure through the window; an optical module positioned within the enclosure, the optical module comprising: a plate having openings patterned for spinning-disc confocal microscopy; and an image sensor, wherein the optical module is configured to illuminate the one or more biological samples with the first light and capture images of the second light from the one or more biological samples; and a cable guide configured to facilitate movement of the optical cable within a first plane and within a second plane that occurs in response to movement of the enclosure, wherein the first plane is substantially perpendicular to the second plane.

A second example is a method of operating an optical instrument to image a biological sample, the method comprising: moving an optical module in a first direction relative to a stage that supports the biological sample, thereby causing an optical cable connected to the optical module and held within a cable guide to move within a first plane that is substantially parallel to the first direction; moving the optical module in a second direction relative to the stage, thereby causing the optical cable held within the cable guide to move within a second plane that is substantially parallel to the second direction, thereby aligning the optical module with the biological sample, wherein the second direction is substantially perpendicular to the first direction; and capturing an image of the biological sample using an image sensor contained in the optical module.

A third example is a non-transitory computer readable medium storing instructions that, when executed by a computing device operably coupled to the optical instrument of the first example, cause the optical instrument to perform the method of the second example.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

The entire contents of U.S. Application no. xx/xxx,xxx, filed on xxxx, denoted as attorney docket no. 25-0399-US, is hereby incorporated by reference herein.

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of a computing device, according to an example.

FIG. 2 is a block diagram of a computing device, a light source, and an optical instrument contained within an environmental chamber, according to an example.

FIG. 3 is a schematic diagram of an optical instrument, an environmental chamber, and a computing device, according to an example.

FIG. 4 is a schematic diagram of an optical instrument contained by an enclosure, according to an example.

FIG. 5 is a schematic diagram of an optical instrument with an enclosure removed, according to an example.

FIG. 6 is a schematic diagram of an enclosure, a selection module, and a transmission light module, according to an example.

FIG. 7 is another schematic diagram of an enclosure, a selection module, and a transmission light module, according to an example.

FIG. 8 is a cross-sectional view of an optical module positioned within an enclosure, according to an example.

FIG. 9 is a schematic diagram of a plate, according to an example.

FIG. 10 is a schematic diagram of an optical instrument covered by an enclosure, according to an example.

FIG. 11 is a schematic diagram of an optical instrument with an enclosure removed, according to an example.

FIG. 12 is a schematic diagram of an optical instrument, showing an optical cable making a turn from a horizontal run to a vertical run along an interior seam of an enclosure, according to an example.

FIG. 13 is a schematic diagram of an optical instrument, according to an example.

FIG. 14 is a schematic diagram of an optical instrument, showing a transparent view of a cable chain, according to an example.

FIG. 15 is a schematic diagram of another view of an optical instrument, showing a cable chain and a portion of an optical cable entering a loop guide, according to an example.

FIG. 16 is a schematic diagram of a loop guide, according to an example.

FIG. 17 is an alternate view of a loop guide, according to an example.

FIG. 18 is a schematic diagram of a portion of a cable guide that is formed by a carriage, according to an example.

FIG. 19 is another schematic diagram of a cable guide, according to an example.

FIG. 20 is a schematic diagram of an enclosure and a cable chain, according to an example.

FIG. 21 shows a biological sample, according to an example.

FIG. 22 shows a biological sample, according to an example.

FIG. 23 shows functionality related to imaging a calibration sample, according to an example.

FIG. 24 is a block diagram of a method, according to an example.

### DETAILED DESCRIPTION

As noted above, conventional instruments for imaging live cells have some limitations. For example, various instruments mechanically disturb the cells during use of the instrument, which can affect the state of the cells or the integrity of the images captured. Described herein are examples of optical instruments and methods of operation that can help alleviate some of these issues.

An optical instrument includes an enclosure that includes a window and a port configured to receive a first light via an optical cable. The first light is typically an excitation light in the form of a laser beam. The optical instrument also includes a stage configured to support or hold one or more biological samples (e.g., live cells). The optical instrument also includes an objective configured to be aligned with the window such that the first light exiting the enclosure through the window enters the objective and a second light from the objective (e.g., from the samples) enters the enclosure through the window. During use of the optical instrument, the objective is typically aligned with a sample such that the second light originating from the sample is collected and focused by the objective and passes through the window into the enclosure. The optical instrument includes a plate (e.g., a disc) having openings such as pinholes patterned for spinning disc confocal microscopy. The plate is configured to be inserted into or removed from an optical path of the optical instrument, depending on the mode of operation. The optical module also includes an image sensor. The optical module is configured to illuminate the one or more biological samples with the first light and capture images of the second light from the one or more biological samples using the image sensor. The optical instrument also includes a cable guide configured to facilitate movement of the optical cable within a first plane and within a second plane that occurs in response to movement of the enclosure. The first plane is substantially perpendicular to the second plane. Thus, the cable guide allows for the optical cable to follow the enclosure in two dimensions without the optical cable kinking or getting snagged on other components of the optical module, so that the optical module can be selectively aligned with various samples for imaging. This allows for the biological samples to remain stationary and undisturbed while the optical module moves around to image samples of interest.

As described in more detail below, embodiments of the aforementioned optical instrument are configured to provide minimal mechanical disturbance to the live cells during imaging and analysis, including during spinning disc confocal microscopy. Confocal microscopy reduces out-of-focus light, thereby enabling optical sectioning of three-dimensional biological structures. Spinning disc confocal microscopy enables high acquisition speeds due to parallelization of the openings (e.g., pinholes) within the spinning disc.

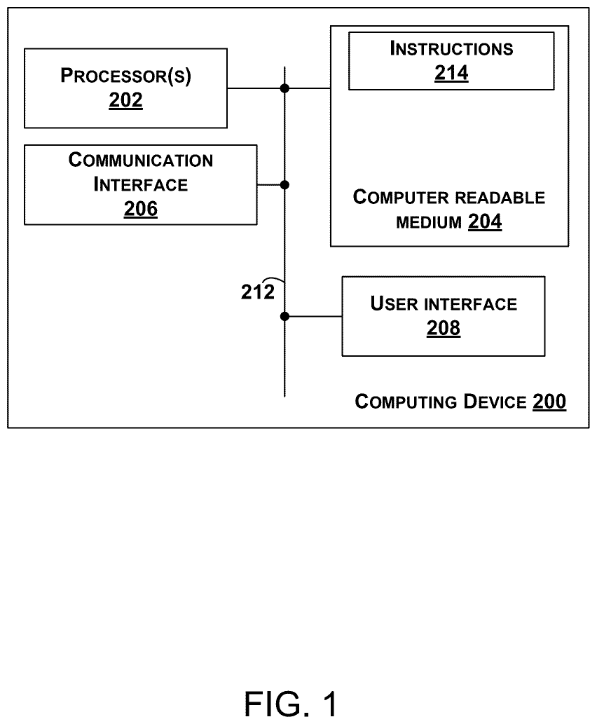

FIG. 1 is a block diagram of a computing device 200. The computing device 200 includes one or more processors 202, a non-transitory computer readable medium 204, a communication interface 206, and a user interface 208. Components of the computing device 200 can be linked together by a system bus, network, or other connection mechanism 212.

The one or more processors 202 can be any type of processor(s), such as a microprocessor, a field programmable gate array, a digital signal processor, a multicore processor, such as a central processing unit (CPU), or a graphics processing unit (GPU), etc., coupled to the non-transitory computer readable medium 204.

The non-transitory computer readable medium 204 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 204 may store instructions 214. The instructions 214 can be executable by the one or more processors 202 to cause the computing device 200 to perform any of the functions or methods described herein.

The communication interface 206 includes hardware to enable communication within the computing device 200 and/or between the computing device 200 and one or more other devices. The hardware can include any type of input and/or output interfaces, a universal serial bus (USB), PCI Express, transmitters, receivers, and antennas, for example. The communication interface 206 can be configured to facilitate communication with one or more other devices, in accordance with one or more wired or wireless communication protocols. For example, the communication interface 206 can be configured to facilitate wireless data communication for the computing device 200 according to one or more wireless communication standards, such as one or more Institute of Electrical and Electronics Engineers (IEEE) 801.11 standards, ZigBee standards, Bluetooth standards, etc. As another example, the communication interface 206 can be configured to facilitate wired data communication with one or more other devices. The communication interface 206 may also include analog-to-digital converters (ADCs) or digital-to-analog converters (DACs) that the computing device 200 can use to control various components of the computing device 200 or external devices.

The user interface 208 includes any type of display component configured to display data. As one example, the user interface 208 can include a touchscreen display. As another example, the user interface 208 can include a flat-panel display, such as a liquid-crystal display (LCD) or a light-emitting diode (LED) display. The user interface 208 includes one or more pieces of hardware used to provide data and control signals to the computing device 200. For instance, the user interface 208 can include a mouse or a pointing device, a keyboard or a keypad, a microphone, a touchpad, or a touchscreen, among other possible types of user input devices. Generally, the user interface 208 may enable an operator to interact with a graphical user interface (GUI) provided by the computing device 200 (e.g., displayed by the user interface 208).

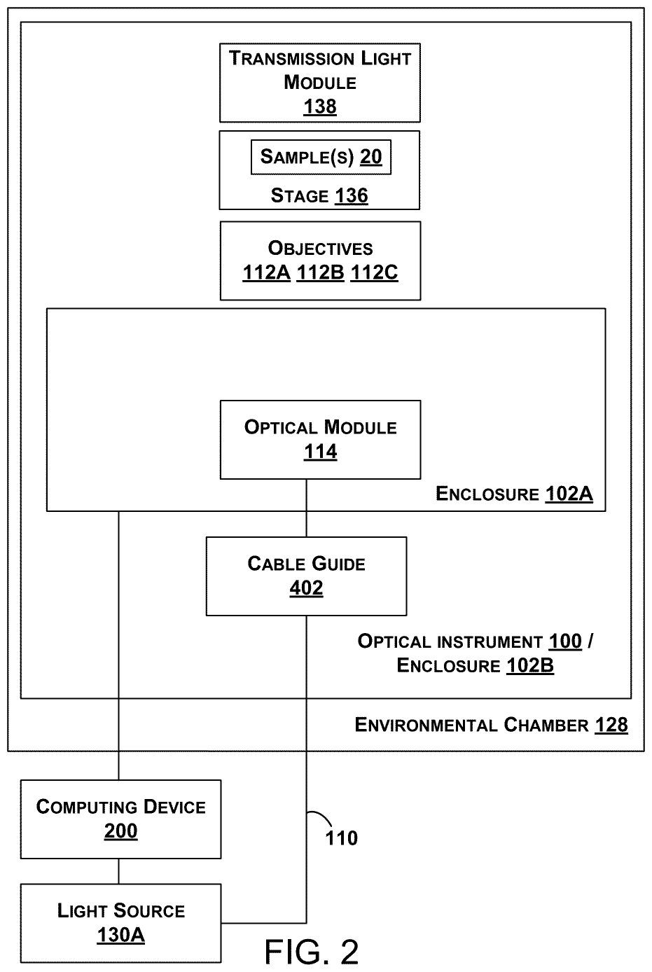

FIG. 2 is a block diagram of the computing device 200, a light source 130A, and an optical instrument 100 contained within an environmental chamber 128. The computing device 200 is configured to control the optical instrument 100 and the light source 130A.

The light source 130A can take the form of one or more lasers and/or one or more light emitting diodes (LEDs), or one or more halogen or arc lamps). The light source 130A is optically coupled to the optical instrument 100 via an optical cable 110 (e.g., a cable including one or more optical fibers such as a multi-mode or single mode fiber). The light source 130A is typically located outside of the environmental chamber 128.

The environmental chamber 128, which can also be referred to as an incubator, is configured to maintain first environmental conditions within the environmental chamber 128 that are different from second environmental conditions outside of the environmental chamber 128. Such environmental conditions controlled by the environmental chamber 128 can include one or more of temperature, humidity, or partial pressure of carbon dioxide.

The optical instrument 100 includes an enclosure 102A that contains an optical module 114. The optical instrument 100 also includes an objective 112A, an objective 112B, an objective 112C, a stage 136 configured to hold one or more biological samples 20, and a transmission light module 138. The optical instrument 100 could also have a different number of objectives than what is shown in FIG. 2. The enclosure 102A is contained within the environmental chamber 128 and an armored portion of the optical cable 110 passes through a wall of the environmental chamber 128.

The optical instrument 100 also includes a cable guide 402 configured to facilitate movement of the optical cable 110 within a first plane and within a second plane that is substantially perpendicular to the first plane. The movement of the optical cable 110 within these two substantially perpendicular planes occurs in response to two-dimensional movement of the enclosure 102A. The cable guide 402 is discussed in more detail below.

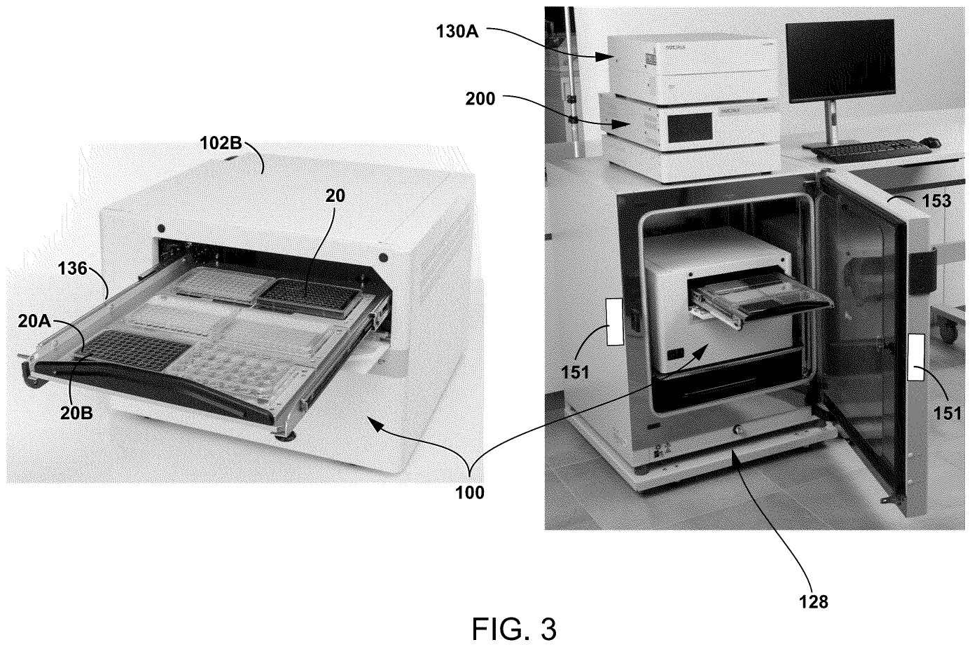

FIG. 3 is a schematic diagram of the optical instrument 100, the environmental chamber 128, and the computing device 200. As shown, the stage 136 can take the form of a retractable drawer and be configured to hold one or more vessels that contain one or more biological samples 20. The optical instrument 100 contained by the enclosure 102B is configured for placement within the environmental chamber 128.

The optical instrument 100 includes an interlock 151 configured to disable the light source 130A in response to a door 153 of the environmental chamber 128 being opened. The interlock 151 can be implemented with a mechanical sensor, an optical sensor, a magnetic sensor, or a hall effect sensor, among other examples.

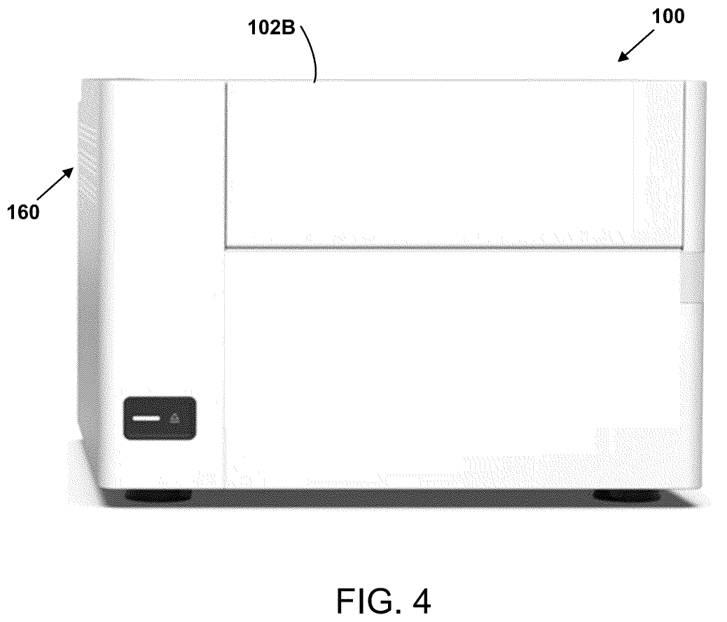

FIG. 4 is a schematic diagram of the optical instrument 100 contained by the enclosure 102B. The enclosure 102B includes a plurality of vents 160 that allow the biological samples 20 within the enclosure 102B to be immersed in the environmental conditions generated by the environmental chamber 128 when the optical instrument 100 and the enclosure 102B are placed within the environmental chamber 128. The enclosure 102B contains the enclosure 102A, the stage 136, the objective 112A, the objective 112B, the objective 112C, the optical module 114, and the cable guide 402.

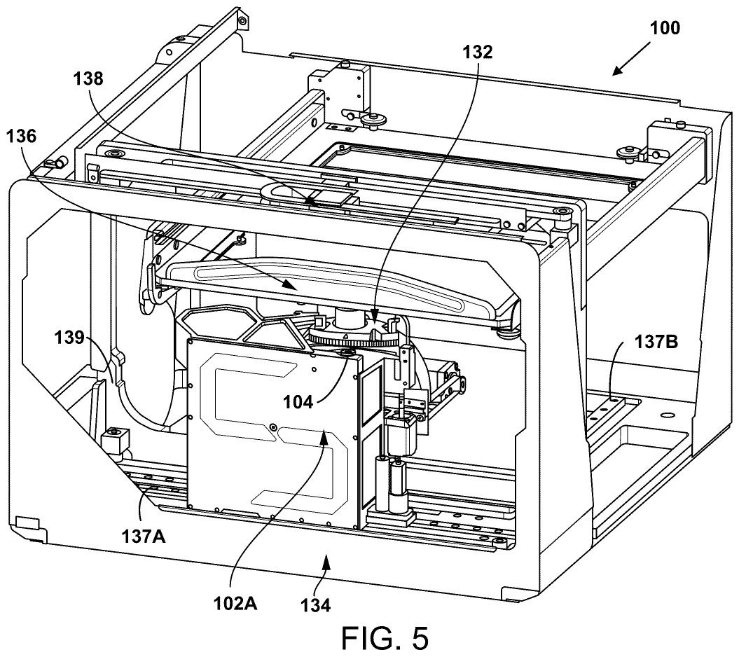

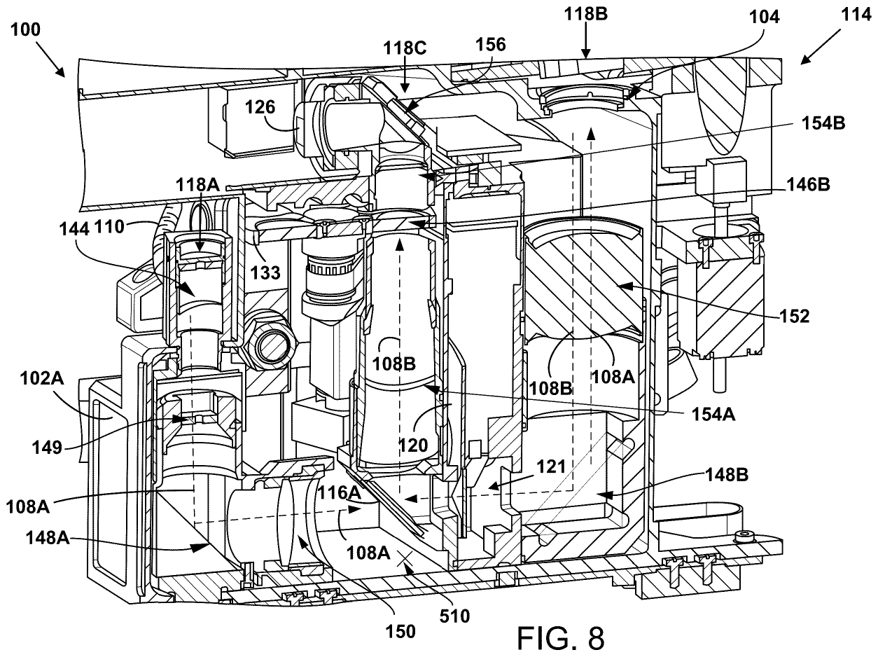

FIG. 5 is a schematic diagram of the optical instrument 100 with the enclosure 102B removed. The optical instrument 100 includes the enclosure 102A. The enclosure 102A can be sealed to maintain, within the enclosure 102A, reduced humidity relative to outside of the enclosure 102A. Referring to FIG. 8, the optical module 114 that is within the enclosure 102A can be at least partially isolated from the environmental conditions maintained by the environmental chamber 128. In some examples, the enclosure 102A is filled with an inert gas (e.g., nitrogen) or dehumidified air). The enclosure 102A also includes a window 104 that is made of glass or plastic, for example. The enclosure 102A can be formed of a material that includes one or more of acetal homopolymer resin, anodized aluminum, or stainless steel. The enclosure 102A can generally be formed of one or more materials that are resistant to swelling in the presence of moisture, non-toxic to cell cultures, resistant to oxidation, resistant to corrosion, and/or resistant to thermal expansion.

The optical instrument 100 also includes a frame 134 configured to support the enclosure 102B (shown in FIG. 4). The frame can be formed of metal (e.g., stainless steel angle iron), but other examples are possible. The frame 134 includes a mechanical interface configured to facilitate movement of the enclosure 102A substantially within a first plane and facilitate movement of the enclosure 102A substantially within a second plane that is substantially perpendicular to the first plane. For example, the mechanical interface can include a rail 137A and a rail 137B that is perpendicular to the rail 137A. In this example, the first plane extends vertically above the rail 137A and the second plane extends parallel with the rail 137B and vertically above the rail 137B. That is, the carriage 139 that holds the enclosure 102A can move along the rail 137B and the enclosure 102A can move along the rail 137A that is positioned on the carriage 139.

The optical module 114 and the enclosure 102A are configured to move with respect to the stage 136 and the frame 134, as controlled by the computing device 200 and one or more motors. For example, the enclosure 102A can move in a direction that coincides with the rail 137A and independently in a direction that coincides with the rail 137B. By moving relative to the stage 136, the optical module 114 can be used to illuminate and capture images of biological samples 20 at different positions on the stage 136 without mechanically disturbing the biological samples 20. The enclosure 102A is slidingly mounted upon the rail 137A that is part of the carriage 139. The carriage 139 and the enclosure 102A can move along the rail 137B as well.

The optical instrument 100 also includes an objective selection module 132 (e.g., a rotatable turret) that is operable such that the objective 112A, the objective 112B, or the objective 112C are selectable for alignment with the window 104.

The optical instrument 100 also includes a transmission light module 138 positioned outside of the enclosure 102A and configured to emit a light beam toward the window 104. During typical operation of the transmission light module 138, a biological sample 20 and the stage 136 will be between the window 104 and the transmission light module 138. The transmission light module 138 is attached to the carriage 139 such that the transmission light module 138 is moved in unison with the enclosure 102A and maintains alignment with the window 104.

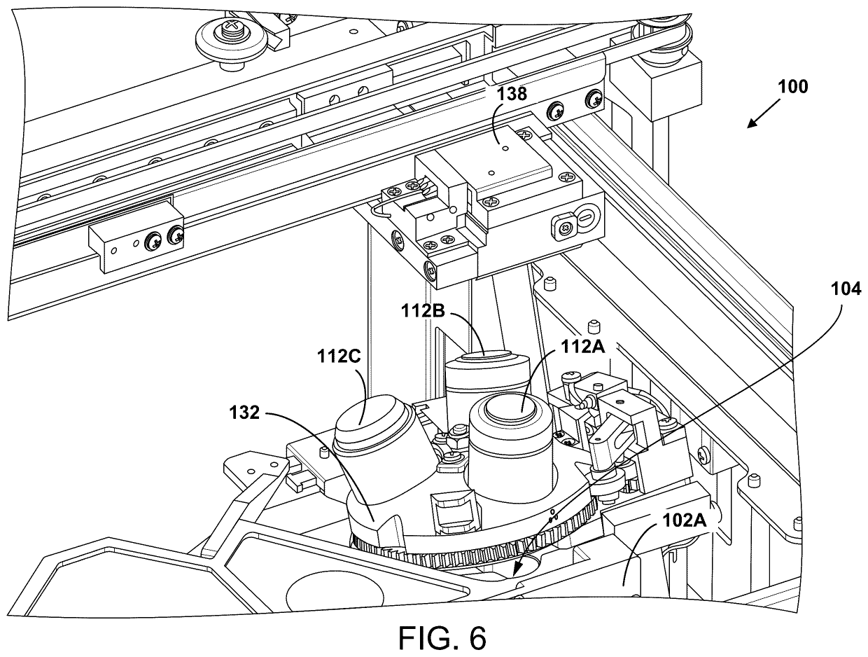

FIG. 6 is a schematic diagram of the enclosure 102A, the objective selection module 132, and the transmission light module 138. The objective selection module 132 is operable (e.g., rotatable) such that the objective 112A, the objective 112B, or the objective 112C are each selectable for alignment with the window 104. For example, when selected and arranged appropriately, the objective 112A is aligned with the window 104 such that light exiting the enclosure 102A through the window 104 enters the objective 112A and light from the objective 112A enters the enclosure 102A through the window 104.

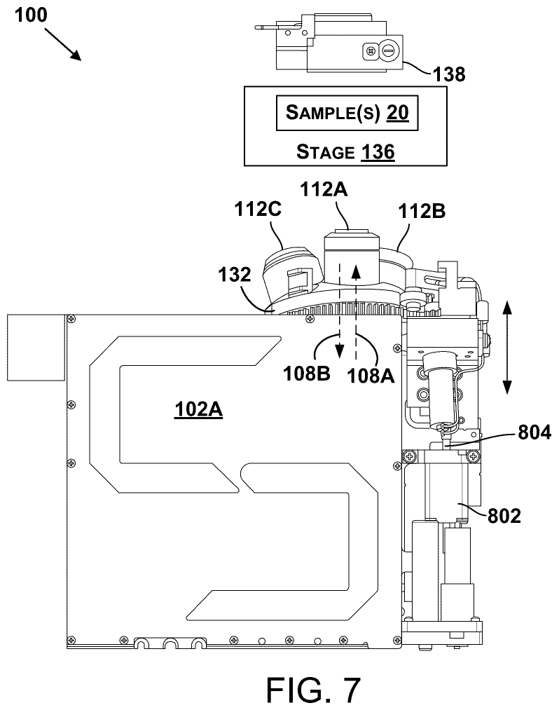

FIG. 7 is another schematic diagram of the enclosure 102A, the objective selection module 132, and the transmission light module 138. During typical operation of the transmission light module 138, the stage 136 and one or more biological samples 20 are between the transmission light module 138 and the objectives 112.

As shown in FIG. 7, the objective 112A is aligned with the window 104 such that the light 108A exiting the enclosure 102A through the window 104 enters the objective 112A and the light 108B from the objective 112B enters the enclosure 102A through the window 104.

The optical instrument 100 adjusts a depth of focus within the biological samples 20 by moving the objective selection module 132 and the objectives 112 up or down with respect to the stage 136. For example, the computing device 200 controls a motor 802 to move a shaft 804 up or down, thereby moving the objective selection module 132 and the objective 112 up or down. The shaft 804 is mechanically coupled to the objective selection module 132.

FIG. 8 is a cross-sectional view of the optical module 114 positioned within the enclosure 102A. The optical module 114 includes a dichroic mirror 116A, first optical elements 118A, second optical elements 118B, a plate 120, an image sensor 126, and third optical elements 118C.

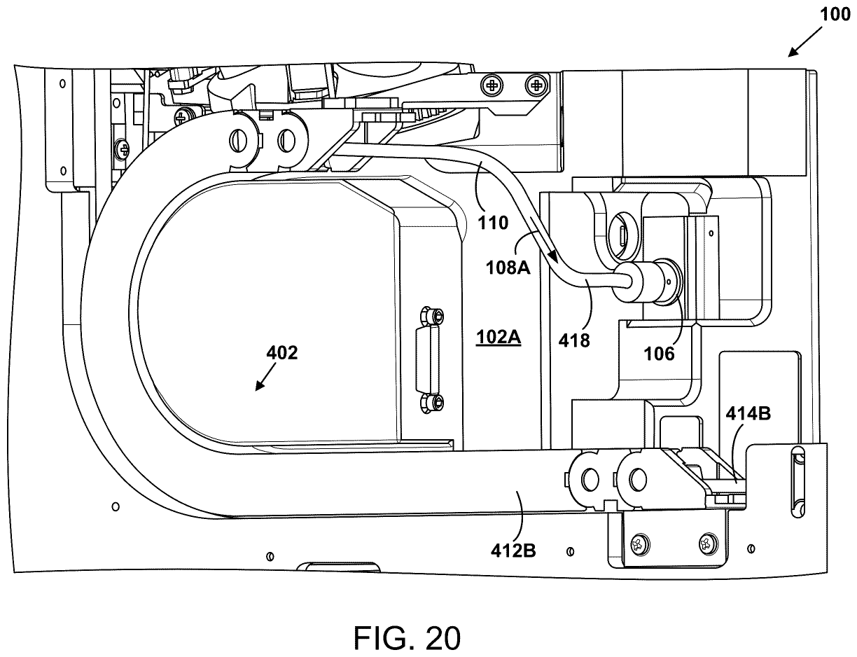

The dichroic mirror 116A can take the form of an interference filter that is configured to reflect light having certain wavelengths and transmit light having other wavelengths. In the particular example shown in FIG. 8, the dichroic mirror 116A is configured to transmit the light 108A that is received via the port 106 from the optical cable 110 and configured to reflect the light 108B that is received from the objective 112A. The port 106 is shown in FIG. 20. The dichroic mirror 116A is interchangeable with other dichroic mirrors having different wavelength-dependent transmission or reflection characteristics.

The first optical elements 118A are configured to direct the light 108A from the port 106 to the dichroic mirror 116A. The first optical elements 118A include a parabolic mirror 144 configured to direct the light 108A received from the port 106 (shown in FIG. 20) toward the dichroic mirror 116A via a rectangular micro lens array 149. The first optical elements 118A further include the rectangular micro lens array 149 configured to shape the light 108A received from the parabolic mirror 144. The optical elements further include a prism mirror 148A configured to reflect the light 108A received from the rectangular micro lens array 149 toward the dichroic mirror 116A. The first optical elements 118A further include a positive lens 150 configured to shape the light 108A received from the prism mirror 148A toward the dichroic mirror 116A. The dichroic mirror 116A is configured to transmit the light 108A from the positive lens 150 toward an area 121 within an optical path of the optical instrument 100. The area 121 might or might not be occupied by the plate 120.

The second optical elements 118B are configured to direct the light 108A from the dichroic mirror 116A, through the window 104, and into the objective 112A and configured to direct the light 108B from the window 104 to the dichroic mirror 116A. The second optical elements 118B include a prism mirror 148B configured to reflect the light 108A from the dichroic mirror 116A toward the window 104 and reflect the light 108B toward the dichroic mirror 116A. The second optical elements 118B further include a tube lens 152 configured to shape the light 108A from the prism mirror 148B and transmit the light 108A through the window 104 to the objective 112A. The tube lens 152 and the objective 112A are configured to focus the light 108A onto a biological sample 20 held by the stage 136 (shown in FIG. 3). The tube lens 152 is also configured to shape the light 108B from the objective 112A and transmit the light 108B to the prism mirror 148B.

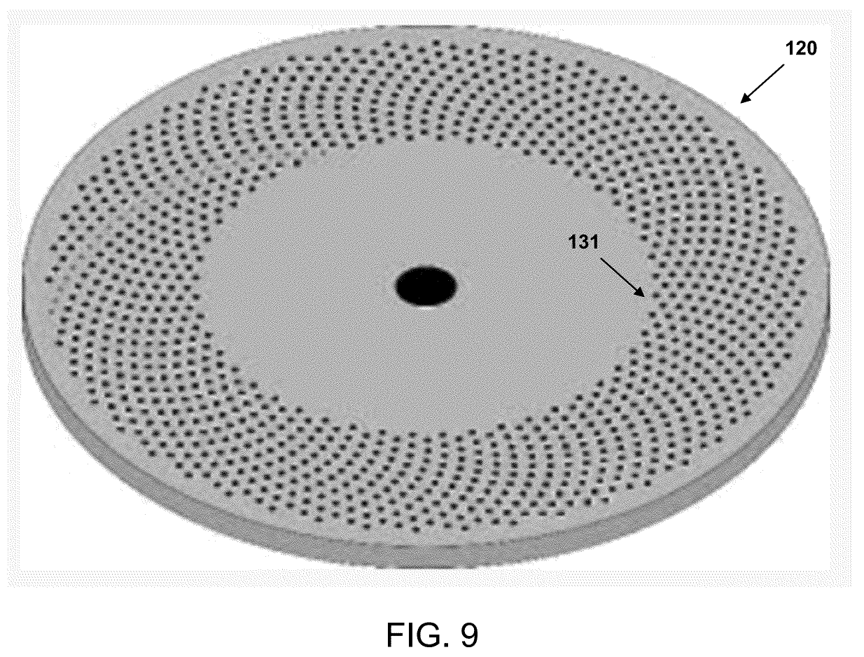

Referring to FIG. 9, the plate 120 has openings 131 patterned for spinning disc confocal microscopy. The plate 120 can take the form of a glass disc that is patterned with paint or metal to reveal the openings 131. The openings 131 can take the form of pinholes arranged in one or more Archimedean spirals, or any other pinhole or slit arrangement within the area 121 that allows for scanning the imaged area optically conjugate to the image sensor 126. The openings 131 are configured to spatially filter the light 108A and the light 108B when the plate 120 is rotating within the area 121.

Referring to FIG. 8, the plate 120 is configured to be inserted into or removed from the area 121 between the dichroic mirror 116A and the second optical elements 118B. The area 121 includes a conjugate focal plane with respect to the image sensor 126. The optical instrument 100 generally operates in a confocal mode when the plate 120 is positioned within the area 121 and operates in a widefield mode when the plate 120 is not positioned within the area 121.

The image sensor 126 can take the form of a complementary metal oxide semiconductor (CMOS) image sensor, but other examples are possible, such as a charge coupled device (CCD), a scientific CMOS (sCMOS) image sensor, or an electron multiplying charge-coupled device (EMCCD).

The third optical elements 118C are configured to direct the light 108B from the dichroic mirror 116A to the image sensor 126. The third optical elements 118C include relay lenses 154A configured to receive the light 108B from the dichroic mirror 116A. The relay lenses 154A are configured to infinitely focus the light 108B. The third optical elements 118C also include another mirror 156 configured to direct the light 108B from the relay lenses 154B to the image sensor 126. The relay lenses 154B are configured to convergently focus the light 108B.

The optical instrument 100 also includes multiple optical filters 146B disposed within a filter selection module 133. The filter selection module 133 is operable (e.g., rotatable) to place a particular optical filter 146B (or no optical filter) between the relay lenses 154A and the relay lenses 154B. Each of the optical filters 146B can have different wavelength-dependent transmission characteristics. Via the filter selection module 133, the optical instrument 100 is configured to insert one or more optical filters 146B between the relay lenses 154A and the relay lenses 154B and configured to remove the one or more optical filters 146B from between the relay lenses 154A and the relay lenses 154B. Typically, at least some of the optical filters 146B are configured to reduce the transmission of the light 108A that strays into the third optical elements 118C.

The first optical elements 118A, specifically the parabolic mirror 144 and the rectangular micro lens array 149, define a first optical axis along which the light 108A travels. The second optical elements 118B define a second optical axis along which the light 108A and the light 108B travel. The third optical elements 118C define a third optical axis along which primarily the light 108B travels. The first optical axis, the second optical axis, and the third optical axis are parallel to each other as shown in FIG. 8.

The optical instrument 100 is configured to operate in a widefield fluorescence mode, a confocal fluorescence mode, a bright field mode, a dark field mode, a reflection mode, and a phase contrast mode.

In the widefield fluorescence mode, the biological sample 20 is illuminated by the light 108A to induce fluorescence from the biological sample 20 in the form of the light 108B. The plate 120 is removed from the area 121 such that images captured by the image sensor 126 are widefield images that are not spatially filtered.

In the confocal fluorescence mode, the biological sample 20 is illuminated by the light 108A to induce fluorescence from the biological sample 20 in the form of the light 108B. The plate 120 is inserted into the area 121 such that images captured by the image sensor 126 are confocal images that are spatially filtered.

In the bright field mode, the biological sample 20 is illuminated by the transmission light module 138. The light 108B represents light that transmits through the biological sample 20 or passes around the biological sample 20. The plate 120 is removed from the area 121 such that images captured by the image sensor 126 are widefield images that are not spatially filtered. Alternatively, the plate 120 is rotated within the area 121 such that images captured by the image sensor 126 are confocal images that are spatially filtered.

In the dark field mode, the transmission light module 138 (see FIG. 7) uses an annulus that prevents almost any light from being transmitted from the transmission light module 138 to the objective 112A through the window 104 and to the image sensor 126. If a biological sample 20 is present between the transmission light module 138 and the objective 112A, the biological sample 20 refracts or scatters the light so that part of that light is then redirected towards the objective 112A and to the image sensor 126.

In the reflection mode, the biological sample 20 is illuminated by the light 108A to induce reflection from the biological sample 20 in the form of the light 108B. The plate 120 is removed from the area 121 such that images captured by the image sensor 126 are widefield images that are not spatially filtered. Alternatively, the plate 120 is rotated within the area 121 such that images captured by the image sensor 126 are confocal images that are spatially filtered.

The phase contrast mode is implemented at least partially through computational means. The optical instrument 100 operating in the phase contrast mode generally involves using an annulus in the transmission light module 138 and including a phase plate as part of the third optical elements 118C and/or the objective(s) 112.

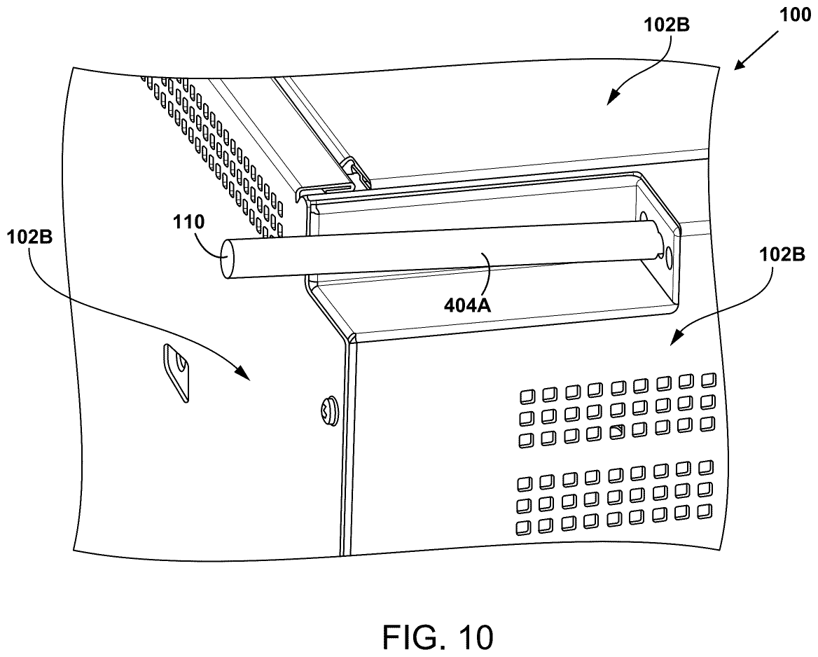

FIG. 10 is a schematic diagram of the optical instrument 100 covered by the enclosure 102B. A portion 404A (e.g., an armored portion) of the optical cable 110 that passes through the enclosure 102B is configured for connection to the light source 130A that generates the light 108A outside of the enclosure 102B.

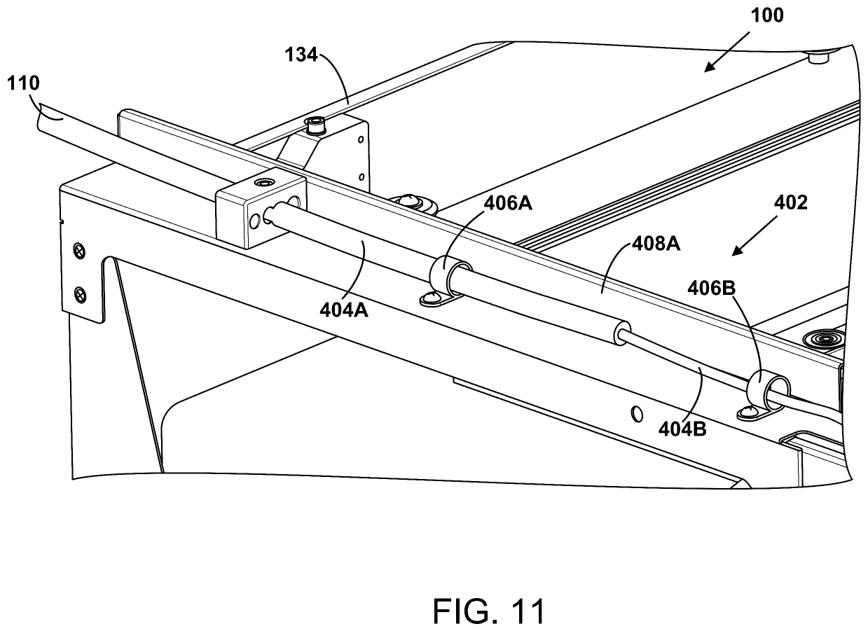

FIGS. 11-20 show various components of the cable guide 402. Such components include cable chains, clamps, and a loop guide.

FIG. 11 is a schematic diagram of the optical instrument 100 with the enclosure 102B removed. The optical cable 110 includes a portion 404B that is entirely contained by the enclosure 102B when the enclosure 102B is present. The portion 404B can be an unarmored portion of the optical cable 110, for example. The optical instrument 100 includes a clamp 406A mounted to the frame 134. The clamp 406A secures the portion 404A to the frame 134. The optical instrument 100 also includes a clamp 406B that secures the portion 404B to the frame 134. More specifically, the clamp 406A and the clamp 406B are mounted to, and secure the optical cable 110 to, a member 408A of the frame 134.

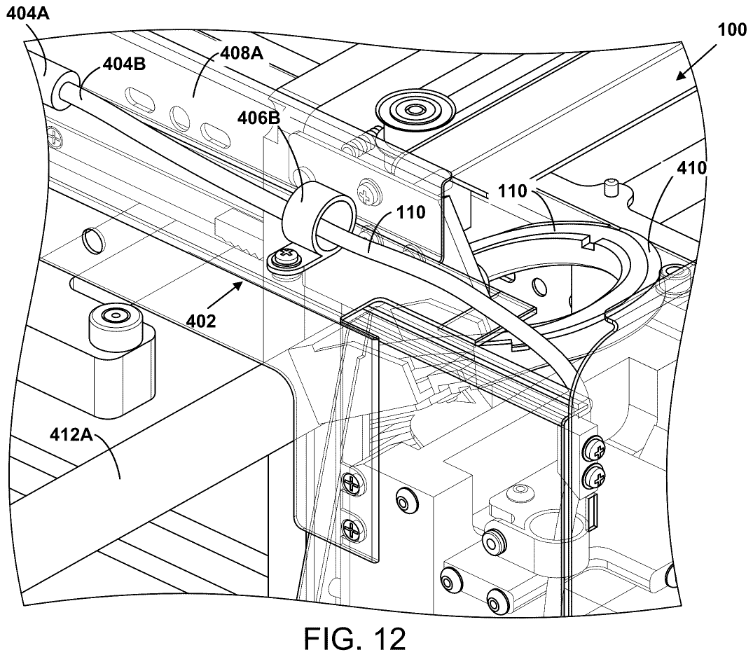

FIG. 12 is a schematic diagram of the optical instrument 100, showing the optical cable 110 making a turn from a horizontal run to a vertical run along an interior seam of the enclosure 102B. As shown, is the cable guide 402 includes a loop guide 410 and a cable chain 412A that guide the optical cable 110.

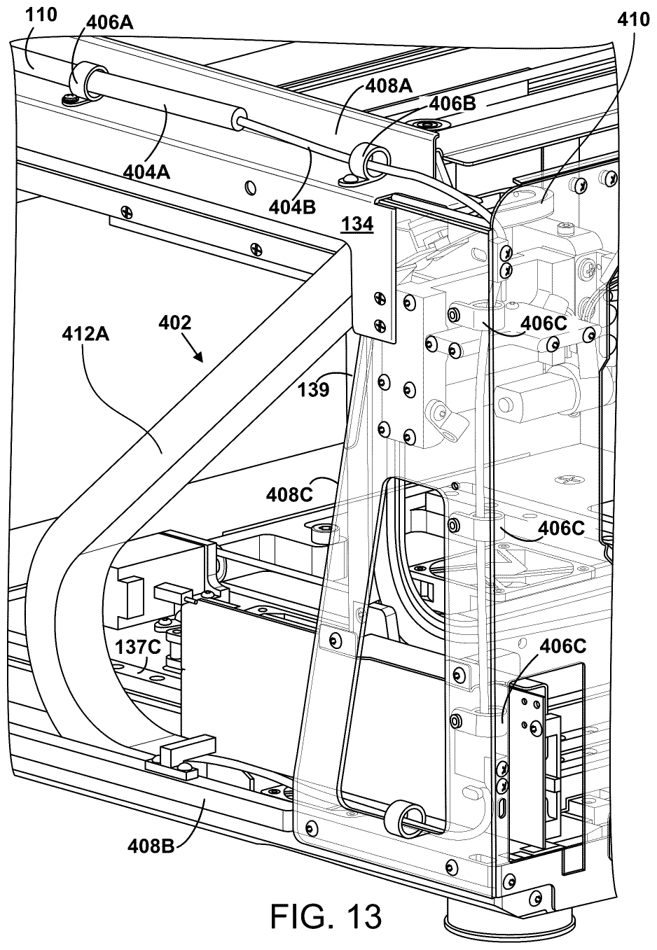

FIG. 13 is a schematic diagram of the optical instrument 100. The frame 134 includes a member 408B that is arranged substantially parallel to the member 408A. The frame 134 also includes a member 408C that connects the member 408A and the member 408B. The cable guide 402 includes clamps 406C that are mounted to the member 408C. The clamps 406C secure the portion 404B of the optical cable 110 to the member 408C. The cable guide 402 also includes the cable chain 412A. The carriage 139 and the enclosure 102A (see FIG. 5) can move along the rail 137C at the same time that the carriage 139 and the enclosure 102A move along the rail 137B (see FIG. 5).

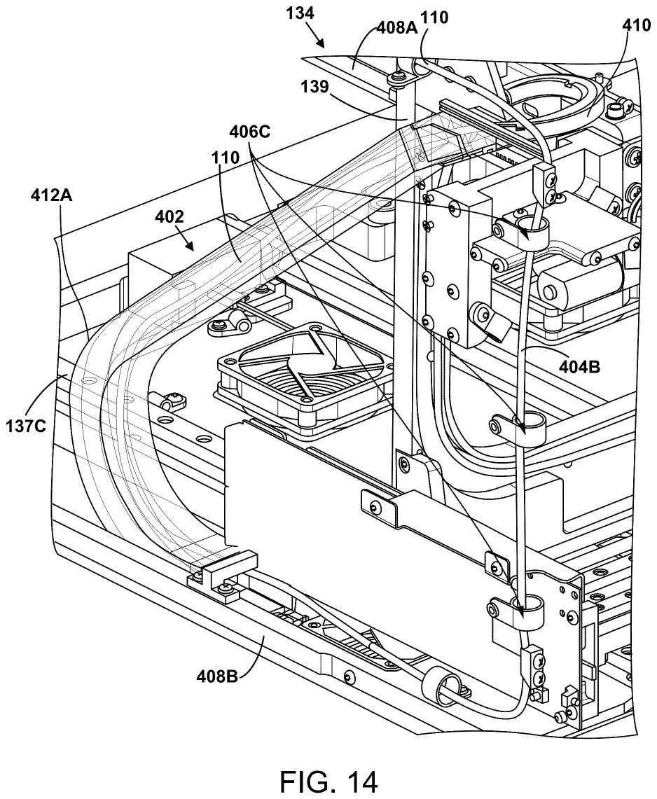

FIG. 14 is a schematic diagram of the optical instrument 100, showing a transparent view of the cable chain 412A. The cable guide 402 includes the cable chain 412A that facilitates movement of the portion 404B of the optical cable 110 within the first plane. The first plane is roughly defined by the path of the optical cable 110 following the member 408A, the member 408C (see FIG. 13), and the member 408B, as shown in FIG. 14. Thus, the first plane is generally parallel to portions of the member 408A, the member 408B, and the member 408C. The first plane is also generally parallel with the rail 137B shown in FIG. 5. The cable chain 412A can be formed of plastic or metal links that are coupled together as a chain to conceal and guard the optical cable 110 while also facilitating movement or bending of the optical cable 110 within the first plane.

The cable guide 402 also includes the loop guide 410 that is mounted to the mechanical interface, that is, mounted to the carriage 139. As noted above, the carriage 139 can move along the rail 137B parallel to the first plane defined by the optical cable 110 following the member 408A, the member 408C, and the member 408B. This movement of the carriage 139 along the rail 137B causes coiling or unfurling of the cable chain 412A, which in turn causes bending or flexing of the optical cable 110, to accommodate the movement of the carriage 139 along the rail 137B and the rail 137C. The cable chain 412A guides the portion 404B of the optical cable 110 into the loop guide 410.

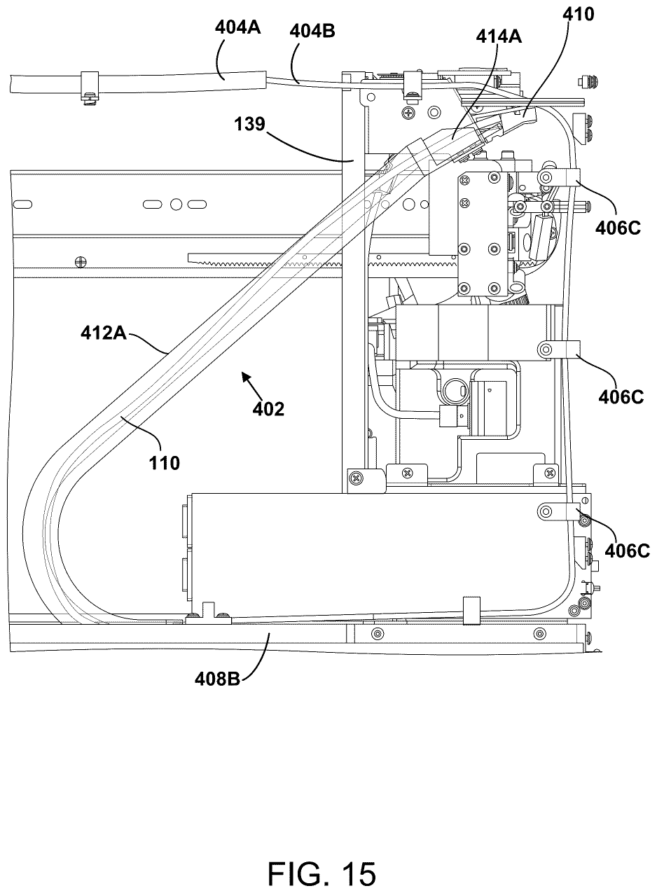

FIG. 15 is a schematic diagram of another view of the optical instrument 100, showing the cable chain 412A and a portion 414A of the optical cable 110 entering the loop guide 410.

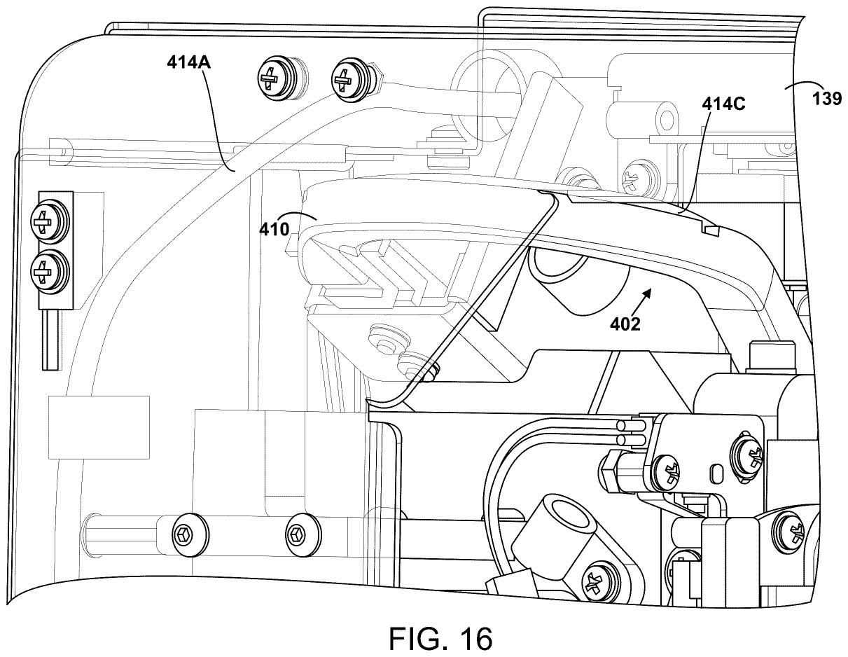

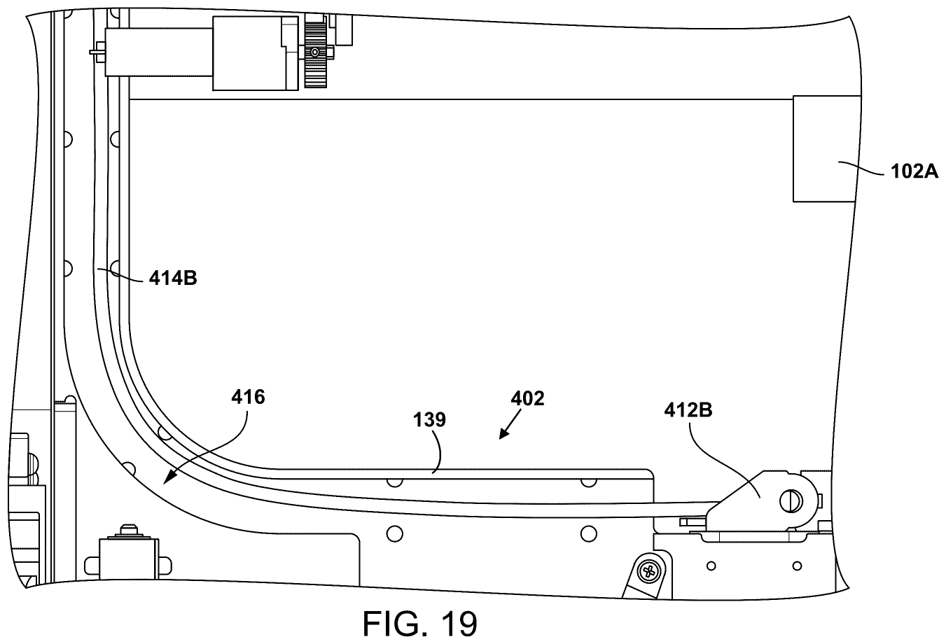

FIG. 16 is a schematic diagram of the loop guide 410. The optical cable 110 can be divided into three portions: a portion 414A that is at least partially positioned within the cable chain 412A, a portion 414B that is at least partially positioned within a cable chain 412B that will be discussed in more detail below, and a portion 414C between the portion 414A and the portion 414B. The portion 414C is positioned within the loop guide 410 and fixed to the mechanical interface, that is, fixed to the carriage 139. The loop guide 410 is an inflexible channel that fixes the portion 414C to the carriage 139, such that the portion 414A of the optical cable 110 can move within the cable chain 412A in response to movement of the carriage 139 along the rail 137B and the rail 137C, and such that the 414B portion of the optical cable 110 can move within the cable chain 412B (as shown in FIG. 19) in response to movement of the enclosure 102A along the rail 137A.

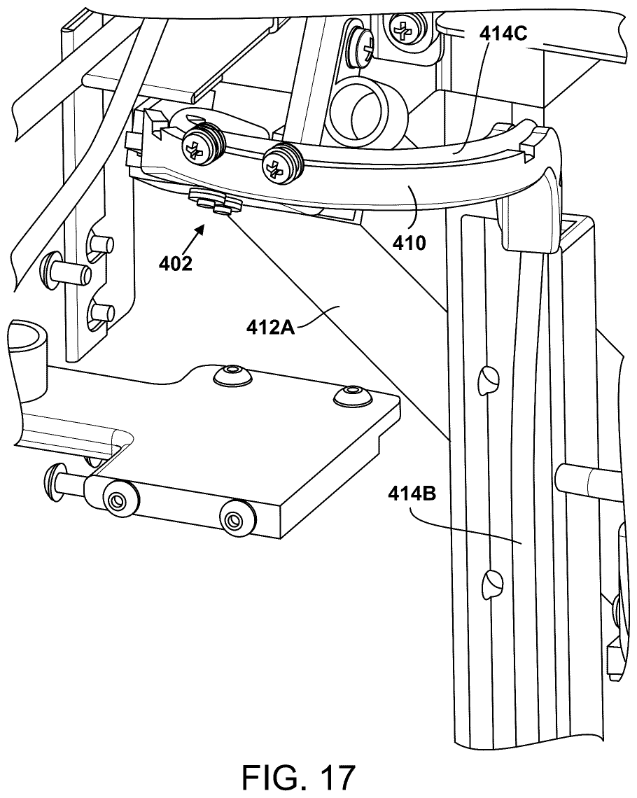

FIG. 17 is an alternate view of the loop guide 410. The portion 414A that is obscured by the loop guide 410 and the cable chain 412A enters the loop guide 410, the portion 414C makes a turn within the loop guide 410, and the portion 414B exits the loop guide 410 downward toward the rail 137A.

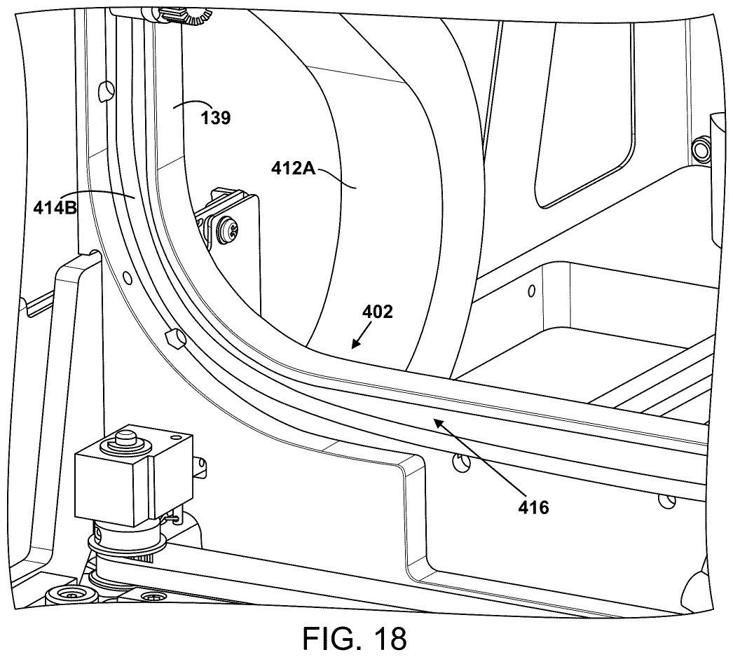

FIG. 18 is a schematic diagram of a portion of the cable guide 402 that is formed by the carriage 139. The mechanical interface in the form of the carriage 139 includes a channel 416 that guides the portion 414B of the optical cable 110 from the loop guide 410 to the cable chain 412B that is shown in FIG. 19.

FIG. 19 is another schematic diagram of the cable guide 402. The cable guide 402 includes the cable chain 412B that facilitates movement of the portion 414B of the optical cable 110 within the second plane. The cable chain 412B can be formed of plastic or metal links that are coupled together as a chain to conceal and guard the optical cable 110 while also facilitating movement or bending of the optical cable 110 within the second plane. The second plane is parallel with the rail 137A and perpendicular to the rail 137B, and is defined by the path of the portion 414B of the optical cable 110 following the channel 416 within the carriage 139.

FIG. 20 is a schematic diagram of the enclosure 102A and the cable chain 412B. The port 106 is configured to receive a light 108A (e.g., a laser beam) via the optical cable 110. Thus, the port 106 typically takes the form of an optical coupler configured to receive an end of the optical cable 110. An end 418 of the optical cable 110 exits the cable chain 412B and connects to the port 106.

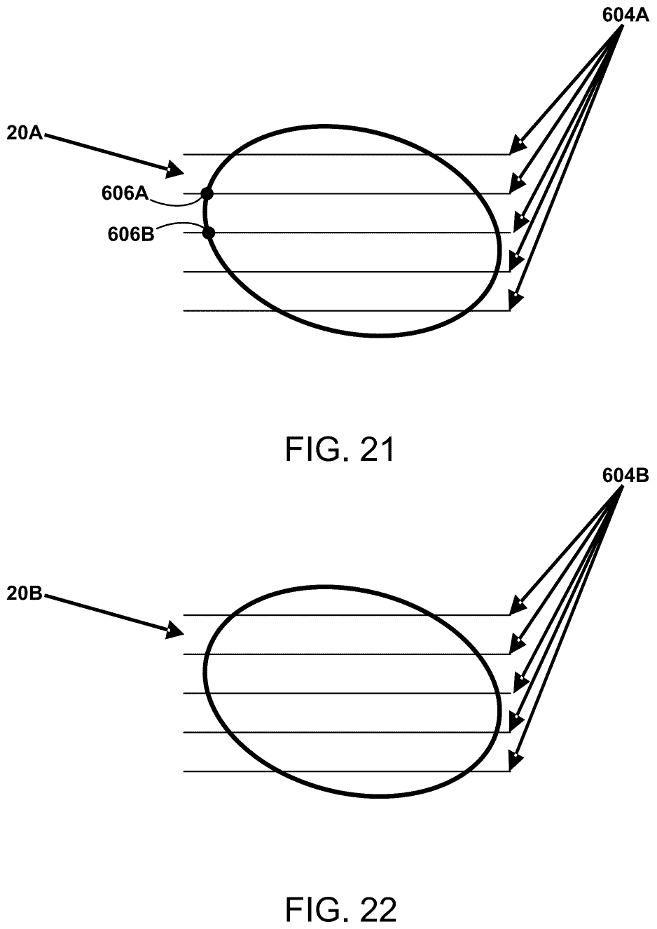

Methods of operating the optical instrument 100 to image biological samples 20 are described below. FIG. 21 shows the biological sample 20A. FIG. 22 shows the biological sample 20B.

Referring as well to FIG. 5, the optical instrument 100 moves the optical module 114 that is within the enclosure 102A in a first direction parallel to the rail 137B and relative to the stage 136 by moving the carriage 139 along the rail 137B and the rail 137C. The stage 136 supports the biological sample 20A (e.g., living cells) and the biological sample 20B (e.g., living cells). The movement of the optical module 114 causes the optical cable 110 connected to the optical module 114 and held within the cable guide 412A to move within the plane defined by the path of the optical cable 110 following the member 408A, the member 408C, and the member 408B, that is, a plane that is parallel to the rail 137B.

The optical instrument 100 also moves the optical module 114 that is within the enclosure 102A in a second direction along the rail 137A relative to the stage 136, thereby causing the optical cable 110 held within the cable guide 412B to move within a plane that is defined by the path of the portion 414B of the optical cable 110 following the channel 416 within the carriage 139, that is, a plane that is parallel to the rail 137A.

The two-dimensional movement of the optical module 114 aligns the optical module 114 with the biological sample 20A. Referring to FIG. 7, vertical movement of the objective selection module 132 adjusts the depth of focus of the optical instrument 100. While the optical module 114 is aligned with the biological sample 20A, the image sensor 126 captures one or more images 604A of the biological sample 20A. In various examples, the one or more images 604A of the biological sample 20A can be captured in a widefield fluorescence mode, a confocal fluorescence mode, a bright field mode, a dark field mode, a reflection mode, or a phase contrast mode. The one or more images 604A could be captured at different focusing depths within the biological sample 20A.

As shown in FIG. 22, the optical instrument 100 can also be used to image the biological sample 20B. The optical instrument 100 moves the optical module 114 that is within the enclosure 102A relative to the stage 136, thereby aligning the optical module 114 with the biological sample 20B supported by the stage 136. While the optical module 114 is aligned with the biological sample 20B, the image sensor 126 captures one or more images 604B of the biological sample 20B. In various examples, the one or more images 604B of the biological sample 20B can be captured in a widefield fluorescence mode, a confocal fluorescence mode, a bright field mode, a dark field mode, a reflection mode, or a phase contrast mode.

FIG. 3 shows the biological sample 20A contained by a first vessel and the biological sample 20B contained by an adjacent second vessel. Other examples are possible. The biological sample 20A and the biological sample 20B could be included in the same vessel and/or share some of the same biological material while having at least some biological material that is not in common. In many contexts, the delineation between the biological sample 20A and the biological sample 20B can correspond with different fields of view captured by the image sensor 126.

Some examples include analyzing an image captured by the optical module 114 and determining whether the overall intensity, total intensity, or variation in intensity depicted by the image falls within an expected range based on operating conditions. The expected range could be known to be associated with the light source 130A or the optical cable 110 having a fault. Thus, the computing device 200 could disable the light source 130A if the image matches the expected range that is associated with a fault.

For example, the computing device 200 uses sensors and/or the state of the software running on the computing device 200 to determine one or more current operating conditions including (i) a temperature of the optical instrument 100 while capturing the image, (ii) an exposure time of the image sensor 126 while capturing the image, (iii) a mode of the optical instrument 100 while capturing the image, and/or (iv) a type of optical filter 146B and/or type of dichroic mirror 116 that was used while capturing the image. The mode of the optical instrument 100 can be defined by one or more of whether the plate 120 is positioned within the area 121 (see FIG. 8), the particular optical elements 118 that are used (see FIG. 8), the vertical position of the objective selection module 132 (see FIG. 7), the position of the optical module 114 along the rail 137A, the rail 137B, and the rail 137C (see FIGS. 5 and 13), or operating parameters of the light source 130A. The computing device 200 can select a metric of an intensity expected for the image captured by the optical instrument 100 under the determined conditions while the light source 130A or the optical cable 110 of the optical instrument 100 is disabled or malfunctioning. Prior to operation, experiments can be conducted to detect ranges of image intensity captured under various operating conditions when the light source 130A and/or the optical cable 110 is experiencing a fault or during normal operating conditions. During operation, the computing device 200 can disable the light source 130A in response to determining that the metric of actual intensity of the image is within a predefined range that includes the metric of the intensity expected for a malfunctioning light source 130A or optical cable 110. The metric of the intensity could include one or more of, on a pixel-by-pixel basis, a maximum intensity, an average intensity, or a median intensity. The metric could also include a standard deviation of all pixel intensities of an image. In some examples, the computing device 200 disables the light source 130A in response to determining that the metric of intensity of a series of images captured by the optical instrument 100 is within a predefined range that includes the metric of the intensity expected for a malfunctioning light source 130A or optical cable 110. For instance, the computing device 200 could repeatedly calculate a running average or perform other mathematical operations upon the series of images and disable the light source 130A in response to determining that the running average or other mathematical operation indicates a malfunctioning light source 130A or optical cable 110.

Referring to FIG. 8, a fiducial marker 510 can be produced within (e.g., etched on) an interior surface of the enclosure 102A and be illuminated by a small portion of the light 108A that is reflected downward toward the fiducial marker 510 by the dichroic mirror 116A. That small portion of light 108A is scattered by interaction with the fiducial maker 510 and can travel through the dichroic mirror 116A and to the image sensor 126. Alternatively, the fiducial marker 510 can be provided on a dichroic mirror 116, one of the optical elements 118A, one of the optical elements 118B, or one of the optical elements 118C. The fiducial marker 510 can be used to determine whether the light source 130A and/or the optical cable 110 are operating correctly. For example, the computing device 200 can make a determination that the fiducial marker 510 is not present within the image of the biological sample 20A and responsively disable the light source 130A. In some examples, the fiducial marker 510 would be expected to be present within the image of the biological sample 20A, perhaps at the edge of a field of view. If the fiducial marker 510 is not present within the image of the biological sample 20A, the computing device 200 can infer that the light source 130A and/or the optical cable 110 is experiencing a fault.

In a similar way, the optical module 114 can capture an additional image while no sample is within a field of view of the optical module 114. The computing device 200 can determine that the fiducial marker 510 is not present within the additional image and responsively disable the light source 130A.

Under some conditions, the computing device 200 can adjust the power provided to the light source 130A instead of disabling the light source 130A. For example, the optical module 114 can capture an additional image of a scattering pattern of the light 108A without a biological sample being adjacent to the objective 112A. The computing device 200 can adjust the power provided to the light source 130A in response to determining that an intensity of the additional image of the scattering pattern is not within a range of intensities that is expected for the scattering pattern. For example, if the actual intensity of the image of the scattering pattern is lower than expected, the computing device 200 can increase the power provided to the light source 130A. Alternatively, if the actual intensity of the image of the scattering pattern is higher than expected, the computing device 200 can decrease the power provided to the light source 130A.

In some examples, the computing device 200 can adjust the power provided to the light source 130A based on the position of the optical module 114, that is, the position of the carriage 139 along the rail 137A and the position of the carriage 139 along the rail 137B and the rail 137C. Prior to operation, experiments can be conducted to discover correlations between the position of the optical module 114 and how efficiently the optical cable 110 transfers electromagnetic energy in the form of the light 108A from the light source 130A to the biological sample 20A. The particular manner that the optical cable 110 bends based on movement of the optical module 114 can affect the power transfer efficiency of the optical cable 110.

For example, the computing device 200 uses position sensors of servo motors to determine the position of the optical module 114 along the first direction (e.g., along the rail 137B and the rail 137C) and along the second direction (e.g., along the rail 137A). Then, the computing device 200 determines a power to be provided to the light source 130A based on a known power transfer ratio corresponding to the current position of the optical module 114. The known power transfer ratio is a power of light captured by a photodetector (e.g., aligned with the window 104) divided by a power provided to the light source, while the optical module 114 is at the particular position. In some examples, the photodetector could be the image sensor 126. The computing device 200 controls the light source 130A to provide the light 108A with the power that is determined using the known power transfer ratio, thereby illuminating the biological sample 20A with the light 108A. In this context, the image sensor 126 captures the light 108B from the biological sample 20A resulting from illuminating the biological sample 20A with the light 108A.

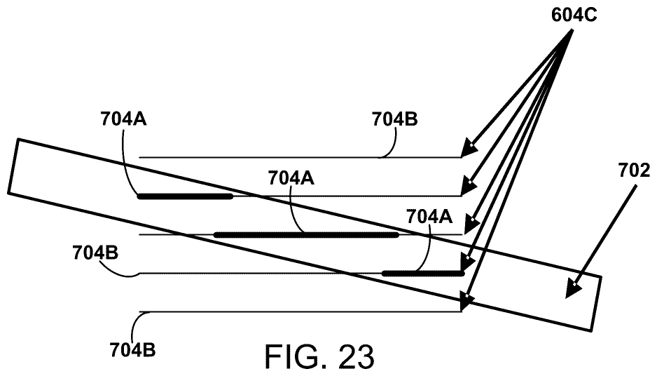

There are multiple methods for experimentally obtaining the known power transfer ratios corresponding to various horizontal positions of the optical module 114. These methods generally involve using a calibration sample 702 (see FIG. 23). The calibration sample 702 is a thin material sample that exhibits fluorescence that is uniform in intensity and spectrum throughout the entire calibration sample 702 when illuminated with a spatially uniform and monochromatic beam. For example, one can place the calibration sample 702 on a calibration stage that is opposite the objective 112A and configured to move horizontally in unison with the optical module 114. The objective selection module 132 can be moved vertically such that the calibration sample 702 is in focus with respect to the image sensor 126. The image sensor 126 can be used to capture images corresponding to many different positions of the optical module 114. These images can be used to determine a known power transfer ratio for each position of the optical module 114. Similar images can be obtained by using a calibration sample 702 having an area that covers the entire horizontal range of movement of the optical module 114 or by using an array of calibration samples that are placed at many different horizontal positions that cover the entire horizontal range of movement of the optical module 114. Using the fluorescent response from the calibration sample 702 and detecting spatial variations in intensity of the second light 108B with the image sensor 126, one can infer the spatial intensity variations in the light 108A that occur due to the position of the optical module 114 along the rails 137A-C.

The known power transfer ratios can be obtained another way. For instance, the optical instrument can be configured such that no optical filter 146 or a weakly attenuating optical filter 146 is positioned between the dichroic mirror 116A and the mirror 156. Under this calibration configuration, no calibration sample 702 or biological sample 20 is necessary. Some amount of the light 108A will reflect off the dichroic mirror 116A and be captured by the image sensor 126. The known power transfer ratios can be inferred based on the intensity variations within these images associated with horizontal positions of the optical module 114.

FIG. 23 shows functionality related to imaging a calibration sample 702. The calibration sample 702 can be made of a fluorescent material or an optically thin capsule filled with a fluorescent dye. When the calibration sample 702 is illuminated uniformly, the calibration sample 702 will exhibit homogeneous fluorescent intensity, including within any section of a horizontal plane that is entirely contained within the calibration sample 702.

When the calibration sample 702 is illuminated obliquely as shown in FIG. 23, the portions 704A of images 604C that are focused within the calibration sample 702 generally exhibit a fluorescence response that is more intense than the portions 704B of the images 604C that are focused either above or below the calibration sample 702, because the fluorescence intensity from the portions 704B are out of focus and actually originate from a different vertical plane that is within the calibration sample 702.

If the calibration sample 702 is aligned to be perfectly horizontal (e.g., normal to the light 108A), one can infer that any non-uniform fluorescence exhibited by the calibration sample 702 is due to the light 108A having intensity variations at different locations within the beam spot and/or due to non-ideal characteristics of the optical cable 110, the objectives 112, the optical elements 118A, the optical elements 118B, the optical elements 118C, the dichroic mirror 116, and/or the image sensor 126. If the calibration sample 702 is imaged a single time with a non-zero tilt, issues can arise because the detected fluorescence will no longer be uniform across the calibration sample 702, even if induced by an ideal beam spot that has uniform intensity over the entire beam spot and captured by optical elements lacking non-idealities.

Thus, the optical module 114 captures the images 604C at different depths within the calibration sample 702 while illuminating the calibration sample 702 with the light 108A generated by the light source 130A. The images 604C obtained from different depths within the calibration sample 702 can be used to compensate for the non-zero tilt of the calibration sample 702, as long as the overall depth of focus of the images 604C extends beyond the vertical extent of the calibration sample 702 on both sides. The computing device 200 processes the images 604C using a projection algorithm to generate a composite image of the calibration sample 702. The projection algorithm can be a maximum projection algorithm, a sum projection algorithm, or an average projection algorithm, for example. For example, the projection algorithm could analyze pixels from each of the images 604C that correspond to the same horizontal location (e.g., a vertical column of pixels) and assign the maximum intensity of those pixels, the sum of the intensities of those pixels, or the average intensity of those pixels to the corresponding pixel of the composite image of the calibration sample 702. Alternatively, the projection algorithm could analyze clusters of pixels from each of the images 604C that correspond to the same horizontal location (e.g., a vertical column of pixel clusters) and assign the maximum intensity of those pixel clusters, the sum of the intensities of those pixel clusters, or the average intensity of those pixel clusters to the corresponding (e.g., center) pixel of the composite image of the calibration sample 702. By analyzing pixel clusters, the projection algorithm can minimize the introduction of noise into the composite image of the calibration sample 702.

The composite image of the calibration sample 702 generally includes information characterizing the spatial variations in intensity of the light 108A and the non-idealities of the optical cable 110, the objectives 112, the optical elements 118A, the optical elements 118B, the optical elements 118C, the dichroic mirrors 116, and/or the image sensor 126. The computing device 200 can use the composite image of the calibration sample 702 to process the one or more images 604A and/or the one or more images 604B to account for spatial variations in intensity of the light 108A and the non-idealities of the optical cable 110, the objectives 112, the optical elements 118A, the optical elements 118B, the optical elements 118C, the dichroic mirrors 116, and/or the image sensor 126 represented by the one or more images 604A and/or the one or more images 604B.

In some examples, the optical instrument 100 can be used to generate composite images of the biological sample 20A or the biological sample 20B. Thus, the optical module 114 captures the images 604A of the biological sample 20A. The images 604A are focused at different depths within the biological sample 20A and can be captured using a spinning disc confocal fluorescence mode of the optical instrument 100. The computing device 200 processes the images 604A using a projection algorithm to generate a composite image of the images 604A. The projection algorithm can take the form of a maximum projection algorithm, a sum projection algorithm, or an average projection algorithm. As part of the process of generating the composite image of the images 604A, the computing device 200 can co-register the images 604A prior to processing the images 604A. The computing device 200 can use feature detection techniques or computer vision to identify one or more objects within the composite image of the images 604A and generate output representing properties of the one or more objects.

In some examples, the computing device 200 recognizes distinct features from different images and infers that the features belong to a common object. For example, the optical module 114 captures the images 604A that represent different focus depths within the biological sample 20A. The computing device 200 identifies a feature 606A within a first image and a feature 606B within a second image. The computing device 200 can use imaging processing techniques to determine that the feature 606A and the feature 606B represent an object (e.g., the biological sample 20A) that is shown in the same horizontal position in the first image and in the second image. The computing device 200 can also generate output via the user interface 208 identifying the object and/or properties of the object. This process can involve the computing device 200 co-registering the images 604A prior to identifying the feature 606A and the feature 606B.

In some examples, the computing device 200 compares the images 604A to identify objects (e.g., three-dimensional objects) within the images 604A. The optical module 114 captures the images 604A that are focused at different depths within the biological sample 20A via spinning disc confocal microscopy, for example. The computing device 200 identifies the object (e.g., the biological sample 20A) shown in the images 604A by determining that an intensity variation satisfying a predetermined criterion is present between two images of the images 604A. The computing device 200 can then generate output identifying the object and/or properties of the object. This process can involve the computing device 200 co-registering the images 604A prior to identifying the object.

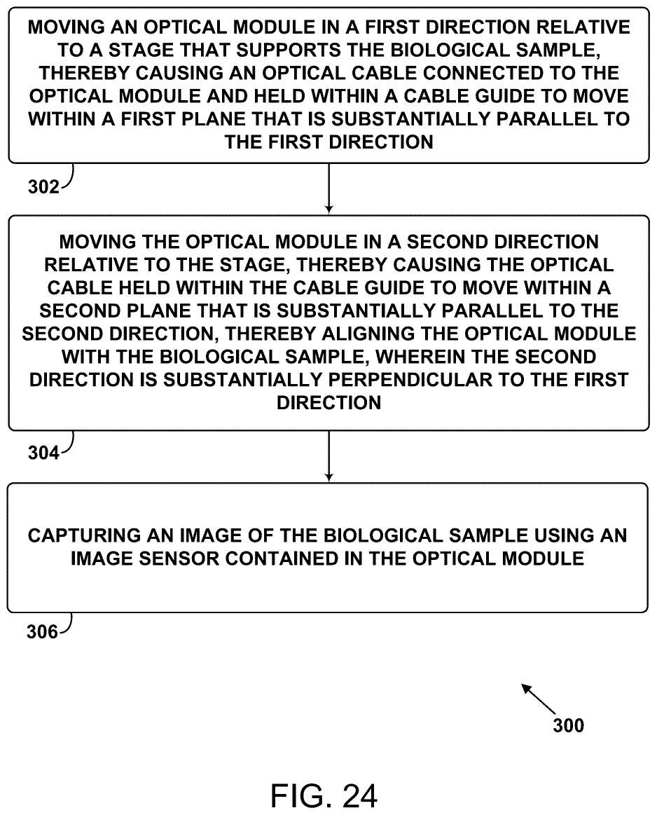

FIG. 24 is a block diagram of a method 300 for operating the optical instrument 100. As shown in FIG. 24, the method 300 includes one or more operations, functions, or actions as illustrated by blocks 302, 304, and 306. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, the method 300 includes the optical instrument 100 moving the optical module 114 in the first direction (e.g., parallel to the rail 137B) relative to the stage 136 that supports the biological sample 20A, thereby causing the optical cable 110 connected to the optical module 114 and held within the cable guide 402 to move within a first plane that is substantially parallel to the first direction. The first plane is defined by the path of the optical cable 110 following the member 408A, the member 408C, and the member 408B. Functionality related to block 302 is discussed above with reference to FIGS. 1-23.

At block 304, the method 300 includes the optical instrument 100 moving the optical module 114 in a second direction (e.g., parallel to the rail 137A) relative to the stage 136, thereby causing the optical cable 110 held within the cable guide 402 to move within a second plane that is substantially parallel to the second direction, thereby aligning the optical module 114 with the biological sample 20A. The second direction is substantially perpendicular to the first direction. The second plane is defined by the path of the portion 414B of the optical cable 110 following the channel 416 within the carriage 139. Functionality related to block 304 is discussed above with reference to FIGS. 1-23.

At block 306, the method 300 includes the optical instrument 100 capturing the images 604A of the biological sample 20A using the image sensor 126 contained in the optical module 114. Functionality related to block 306 is discussed above with reference to FIGS. 1-23.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. An optical instrument comprising:
an enclosure comprising:
a window; and
a port configured to receive a first light via an optical cable;
a stage configured to support one or more biological samples;
an objective configured to be aligned with the window such that the first light exiting the enclosure through the window enters the objective and a second light from the objective enters the enclosure through the window;
an optical module positioned within the enclosure, the optical module comprising:
a plate having openings patterned for spinning-disc confocal microscopy; and
an image sensor,
wherein the optical module is configured to illuminate the one or more biological samples with the first light and capture images of the second light from the one or more biological samples; and
a cable guide configured to facilitate movement of the optical cable within a first plane and within a second plane that occurs in response to movement of the enclosure, wherein the first plane is substantially perpendicular to the second plane.

2. The optical instrument of claim 1, further comprising: a mechanical interface configured to facilitate movement of the enclosure substantially parallel to the first plane and facilitate movement of the enclosure substantially parallel to the second plane.

3. The optical instrument of claim 2, wherein the cable guide comprises a first cable chain that facilitates movement of a first portion of the optical cable within the first plane.

4. The optical instrument of claim 3, wherein the cable guide further comprises a second cable chain that facilitates movement of a second portion of the optical cable within the second plane.

5. The optical instrument of claim 4, wherein an end of the optical cable exits the second cable chain and connects to the port.

6. The optical instrument of claim 4, wherein a third portion of the optical cable between the first portion and the second portion is fixed to the mechanical interface.

7. The optical instrument of claim 2, further comprising: a frame, wherein the optical cable comprises a first portion and a second portion, and wherein the cable guide comprises:
a first clamp mounted to the frame, wherein the first clamp secures the first portion to the frame; and
a second clamp mounted to the frame, wherein the second clamp secures the second portion to the frame.

8. (canceled)

9. The optical instrument of claim 7, wherein the frame comprises a first member, wherein the first clamp and the second clamp are mounted on the first member.

10. The optical instrument of claim 9, the frame further comprising:
a second member that is arranged substantially parallel to the first member; and
a third member that connects the first member and the second member,
the cable guide further comprising one or more third clamps mounted to the third member, wherein the one or more third clamps secure the second portion to the third member.

11. The optical instrument of claim 10, the cable guide further comprising:
a loop guide mounted to the mechanical interface; and
a first cable chain that guides the second portion from the second member to the loop guide and allows for movement of the second portion within the first plane.

12. The optical instrument of claim 11, the cable guide comprising a second cable chain, wherein the mechanical interface comprises a channel that guides the optical cable from the loop guide to the second cable chain.

13. The optical instrument of claim 12, wherein the second cable chain allows for movement of the second portion within the second plane.

14. The optical instrument of claim 12, wherein an end of the optical cable exits the second cable chain and connects to the port.

15. The optical instrument of claim 1, wherein the enclosure is a first enclosure, the optical instrument further comprising a second enclosure that contains the first enclosure, the stage, the objective, the optical module, and the cable guide.

16. The optical instrument of claim 15, wherein the optical cable comprises:
an armored portion that passes through the second enclosure and is configured for connection to a light source that generates the first light outside of the second enclosure; and
an unarmored portion that is entirely contained by the second enclosure.

17-19. (canceled)

20. The optical instrument of claim 1, wherein the enclosure comprising the window and the port is sealed.

21. (canceled)

22. The optical instrument of claim 1, further comprising: an environmental chamber, wherein the enclosure comprising the window and the port is contained within the environmental chamber and an armored portion of the optical cable passes through a wall of the environmental chamber.

23. The optical instrument of claim 22, wherein the environmental chamber is configured to maintain a first temperature within the environmental chamber that is different from a second temperature outside of the environmental chamber, maintain a first humidity within the environmental chamber that is different from a second humidity outside of the environmental chamber, or maintain a first partial pressure of carbon dioxide within the environmental chamber that is different from a second partial pressure of carbon dioxide outside of the environmental chamber.

24-25. (canceled)

26. The optical instrument of claim 22, further comprising: an interlock configured to disable a light source that provides the first light in response to a door of the environmental chamber being opened.

27-30. (canceled)

31. A method of operating an optical instrument to image a biological sample, the method comprising:
moving an optical module in a first direction relative to a stage that supports the biological sample, thereby causing an optical cable connected to the optical module and held within a cable guide to move within a first plane that is substantially parallel to the first direction;
moving the optical module in a second direction relative to the stage, thereby causing the optical cable held within the cable guide to move within a second plane that is substantially parallel to the second direction, thereby aligning the optical module with the biological sample, wherein the second direction is substantially perpendicular to the first direction; and
capturing an image of the biological sample using an image sensor contained in the optical module.

32. The method of claim 31, wherein capturing the image comprises capturing the image in a widefield fluorescence mode, a confocal fluorescence mode, a bright field mode, a dark field mode, a reflection mode, or a phase contrast mode.

33-35. (canceled)

36. The method of claim 31 further comprising:
determining one or more conditions including (i) a temperature of the optical instrument while capturing the image, (ii) an exposure time of the image sensor while capturing the image, (iii) a mode of the optical instrument while capturing the image, and/or (iv) a type of optical filter and/or a type of dichroic mirror that was used while capturing the image;
selecting a metric of an intensity expected for the image captured by the optical instrument under the conditions while a light source of the optical instrument is disabled or malfunctioning; and
disabling the light source in response to determining that a metric of actual intensity of the image is within a predefined range that includes the metric of the intensity expected.

37. The method of claim 36, wherein the metric of the intensity expected comprises one or more of a maximum intensity, an average intensity, a median intensity, or a standard deviation of intensity.

38. The method of claim 31, wherein the optical instrument comprises a light source that generates a light, wherein a fiducial marker is present within the optical instrument and configured to be illuminated by the light, the method further comprising:
making a determination that the fiducial marker is not present within the image; and
disabling the light source in response to making the determination.

39. (canceled)

40. The method of claim 31, wherein the optical instrument comprises a light source that generates a light, the method further comprising:
capturing a second image of a scattering pattern of the light without a biological sample being adjacent to an objective of the optical instrument; and
adjusting a power provided to the light source in response to determining that an intensity of the second image is not within a range of intensities that is expected for the scattering pattern.

41. The method of claim 31, further comprising:
determining a position of the optical module along the first direction and along the second direction;
determining a first power to be provided to a light source of the optical instrument based on a known power transfer ratio corresponding to the position, wherein the known power transfer ratio is a second power of light captured by a detector divided by a third power provided to the light source while the light is captured by the detector and the optical module is at the position; and
controlling the light source to provide a first light with the first power, thereby illuminating the biological sample with the first light, wherein
capturing the image of the biological sample comprises capturing a second light from the biological sample resulting from illuminating the biological sample with the first light.

42. The method of claim 41, wherein the detector is the image sensor.

43. The method of claim 31, wherein the image is a first image, the method further comprising:
capturing second images focused at different depths within a calibration sample while illuminating the calibration sample with a first light generated by a light source;
processing the second images using a projection algorithm to generate a composite image of the calibration sample; and
processing the first image using the composite image to compensate for spatial variations in intensity of the first light represented by the first image.

44. The method of claim 31, further comprising:
capturing one or more additional images of the biological sample, wherein the one or more additional images are focused at different depths within the biological sample; and
processing the one or more additional images using a projection algorithm to generate a composite image of the one or more additional images.

45-50. (canceled)

51. The method of claim 44, wherein capturing the one or more additional images comprises capturing the one or more additional images using a spinning disc confocal fluorescence mode of the optical instrument.

52. The method of claim 31, wherein the image is a first image, the method further comprising:
capturing a second image of the biological sample, wherein the first image and the second image are focused at different depths within the biological sample;
identifying a first feature within the first image and a second feature within the second image;
determining that the first feature and the second feature represent an object that is shown in the same position in the first image and in the second image; and
generating output identifying the object and/or properties of the object.

53. (canceled)

54. The method of claim 31, wherein the image is a first image, the method further comprising:
capturing a second image of the biological sample, wherein the first image and the second image are focused at different depths within the biological sample;
identifying an object shown in the first image and in the second image by determining that an intensity variation satisfying a predetermined criterion is present between the first image and the second image; and
generating output identifying the object and/or properties of the object.

55. The method of claim 54, wherein capturing the second image comprises capturing the second image using a spinning disc confocal fluorescence mode of the optical instrument.

56. (canceled)

57. The method of claim 31, wherein the image is a first image, the method further comprising:
capturing a second image of the biological sample, wherein the first image and the second image are captured using different modes of the optical instrument;
identifying an object shown in the first image and in the second image; and
generating output identifying the object and/or properties of the object.

58. A non-transitory computer readable medium storing instructions that, when executed by a computing device operably coupled to an optical instrument, cause the optical instrument to perform functions comprising:
moving an optical module in a first direction relative to a stage that supports the biological sample, thereby causing an optical cable connected to the optical module and held within a cable guide to move within a first plane that is substantially parallel to the first direction;
moving the optical module in a second direction relative to the stage, thereby causing the optical cable held within the cable guide to move within a second plane that is substantially parallel to the second direction, thereby aligning the optical module with the biological sample, wherein the second direction is substantially perpendicular to the first direction; and
capturing an image of the biological sample using an image sensor contained in the optical module.
